(19) United States
(12) Patent Application Publication
(10) Pub. No.: US 2016/0363165 A1
(43) Pub. Date: Dec. 15, 2016

(54) AIR BEARING STRUCTURE

(71) Applicant: HIWIN MIKROSYSTEM CORP., Taichung City (TW)

(72) Inventors: Yun Wei LIN, Taichung City (TW); Yu An YEN, Taichung City (TW); Chang-Cheng HO, Taichung City (TW)

(21) Appl. No.: 14/735,091

(22) Filed: Jun. 9, 2015

(51) Int. Cl. F16C 32/06

(52) U.S. Cl. CPC F16C 32/0618; F16C 32/0666

(57) ABSTRACT

An air bearing structure, which is a porous air bearing. In the air bearing structure, a porous material is combined with an aluminum layer with vents to provide double restrictions so as to enhance the degree of freedom in adjusting the diameter parameter of porous material. The vents are distributed in a matrix pattern and have a diameter of nanometer order. Therefore, the uniformity of the vents and the unification of the infiltration can be ensured. Also, the vents can be directed in the same direction to enhance the bearing ability, air film stability and static rigidity.

### BACKGROUND OF THE INVENTION

1. Field of the Invention

The present invention relates generally to an air bearing structure, and more particularly to an improved static-pressure air bearing, which has vents with high depth-diameter ratio.

2. Description of the Related Art

An air bearing is a slide bearing with a gas as a lubricant. By means of the viscosity of the gas, the gas pressure in the gap between two objects moving relative to each other is increased so as to float the objects and bear the load. The air bearing has the characteristics of low frictional coefficient and low frictional torque and is applicable to high-speed motion field. Moreover, the air film formed between the relatively moving end faces can reduce the vibration amplitude of the objects in motion so as to meet the requirement of high motional precision. Besides, the air bearing has the advantages of long lifetime, easy maintenance, free from affection of temperature, etc. Therefore, the air bearing is widely applied in various industries.

In the sophisticated processing machines or measurement instruments necessitating high positioning precision and high-speed motion, under the effects of high-rotational speed and temperature rise, the conventional hydraulic bearing is subject to deformation and heat consumption. This will lead to damage of the hydraulic bearing. In contrast, the static-pressure air bearing has a gas viscosity much smaller than the liquid viscosity of the conventional hydraulic bearing and is especially applicable to high-speed motion. However, consequently, due to the smaller gas viscosity, the bearing ability and rigidity of the static-pressure air bearing are lower. This limits the application range of the air bearing.

With respect to a static-pressure air bearing, a gas supply system is used to supply pressurized gas into a throttling device. Then, the throttling device guides the gas into the voids of the bearing to create static pressure for bearing a load. Different throttling structures lead to different properties of the air bearing. In the conventional throttling devices, the throttling device made of porous material with ventilation effect has better stability and load bearing ability than the others. However, it is relatively difficult to manufacture such throttling device so that the cost for the throttling device is quite high. As a result, such throttling device can be hardly widely employed. Also, it is hard to control the internal voids of the porous material. Therefore, it is hard to optimally adjust and control the diameter and the distribution state of the voids.

### SUMMARY OF THE INVENTION

It is therefore a primary object of the present invention to provide an improved static-pressure air bearing, which has vents with high depth-diameter ratio. The air bearing structure includes a main body made of porous material and a throttling layer section disposed on the porous main body. The throttling layer section is formed of an aluminum layer having multiple vents. The diameter and the distribution state of the vents can be easily changed or adjusted to overcome the shortcoming of the conventional porous throttling air bearing that it is hard to control the diameter and distribution state of the voids. Accordingly, the degree of freedom in adjusting the diameter parameter of the air bearing is enhanced. The static-pressure air bearing of the present invention also has high rigidity and high stability of the conventional porous throttling air bearing to enhance the uniformity of outgoing gas, air film rigidity and airflow stability.

To achieve the above and other objects, the air bearing structure of the present invention includes a porous main body having a base section and an air cavity formed in the base section. The air cavity is composed of multiple voids formed in the base section in communication with each other. The air bearing structure further includes a throttling layer section disposed on one face of the porous main body. The throttling layer section is formed of an aluminum layer having multiple vents with predetermined length. The vents pass through the aluminum layer and are directed in the same direction in communication with the air cavity.

In the above air bearing structure, the aluminum layer is formed on the face of the porous main body by means of physical vapor deposition (PVD).

In the above air bearing structure, the aluminum layer has a thickness ranging from 3 to 5 micrometers.

In the above air bearing structure, the shape of the vents can be changed in accordance with different airflow output requirements. The vents can have unified diameter or non-unified diameter. For example, two ends of each vent can have a diameter larger than the diameter of the middle section of the vent. Alternatively, two ends of each vent can have a diameter smaller than the diameter of the middle section of the vent.

In the above air bearing structure, the vents are uniformly arranged in the aluminum layer at equal intervals with a size ranging 250 to 450 nanometers.

In the above air bearing structure, the ratio of the depth of the vents to the diameter of the vents is at least equal to or larger than 6.

In the above air bearing structure, the vents are formed by a means selected from a group consisting of ultrasonic machining (USM), electrochemical machining (ECM), electrical discharge machining (EDM), laser beam machining (LBM) or electronic beam machining (EBM) and anodic oxidation process (AAO) or the like machining method.

The vents formed through the aluminum layer by means of anodic oxidation process tend to have relatively unified diameter and higher depth-diameter ratio. In this case, the vents can provide better restriction and conduction effect for airflow. Accordingly, the outgoing airflow can be regulated to flow out in a unified direction and fully develop so as to ensure the laminar flow and enhance the stability.

The present invention can be best understood through the following description and accompanying drawings, wherein:

### BRIEF DESCRIPTION OF THE DRAWINGS

FIG. 1 is a sectional view of a first embodiment of the present invention;

FIG. 2 is a sectional view of the first embodiment of the present invention, showing the airflow thereof;

FIG. 3 is a perspective view of a part of the first embodiment of the present invention;

FIG. 4 is a perspective sectional view of a part of the throttling layer section of the first embodiment of the present invention;

FIG. 5 is a perspective sectional view of a part of the throttling layer section of a second embodiment of the present invention;

FIG. 6 is a perspective sectional view of a part of the throttling layer section of a third embodiment of the present invention; and

FIG. 7 is a perspective sectional view of a part of the throttling layer section of a fourth embodiment of the present invention.

### DETAILED DESCRIPTION OF THE PREFERRED EMBODIMENTS

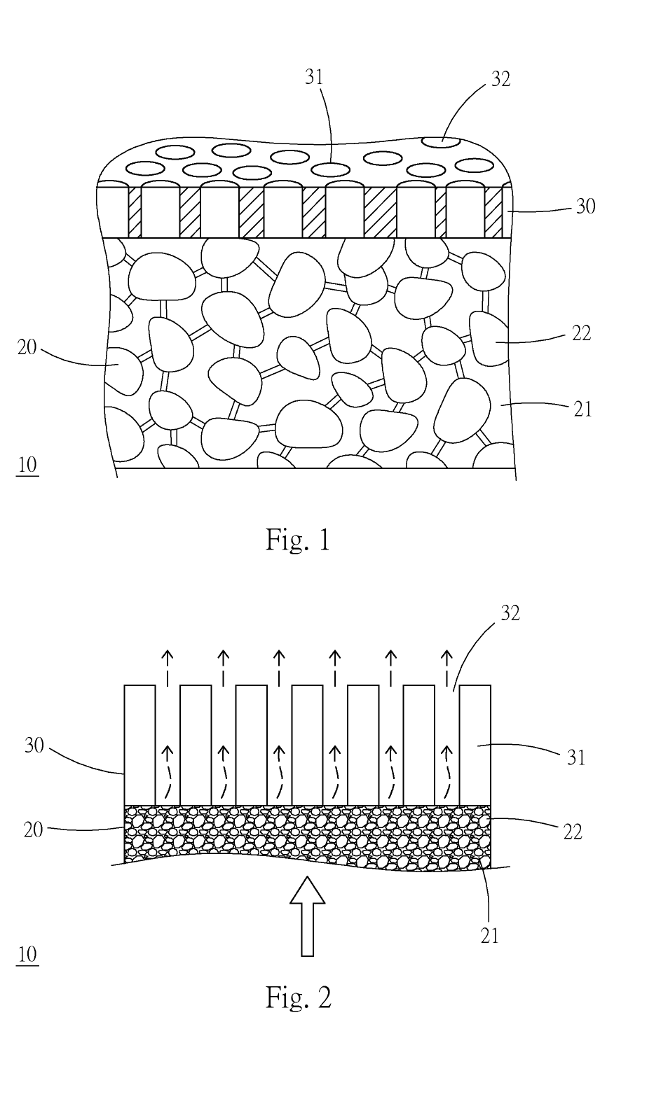

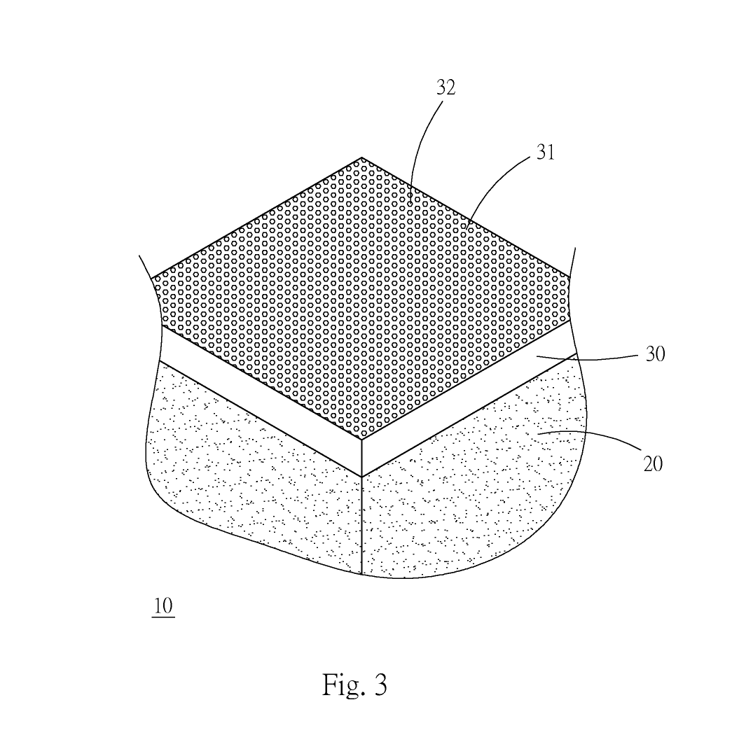

Please refer to FIGS. 1 to 4. According to a first embodiment, the air bearing structure 10 of the present invention includes a porous main body 20 and a throttling layer section 30.

The porous main body 20 is made by means of conventional sintering technique, including a base section 21 and an air cavity 22 formed in the base section 21 and composed of multiple voids in communication with each other. The multiple voids form an airflow path to achieve an effect as that of a conventional porous throttling device.

The throttling layer section 30 is formed of an aluminum layer 31 with multiple vents 32 having predetermined length. The throttling layer section 30 is disposed on one face of the porous main body 20. To speak more specifically, the aluminum layer 31 is formed of aluminum deposited on the face of the porous main body 20 by means of physical vapor deposition (PVD). The aluminum layer 31 has a thickness ranging from 3 to 5 micrometers. Then, the aluminum layer 31 is vaporized to form the vents 32 by means of anodic oxidation process.

The vents 32 formed by anodic oxidation process are directed in the same direction and uniformly distributed in the aluminum layer 31. Substantially, the vents 32 are arranged at intervals with a size ranging 250 to 450 nanometers. The vents 32 are uniformly arranged on the aluminum layer 31 in a matrix pattern. Moreover, the vents 32 can have a nano-order diameter. In this case, in an extremely thin aluminum layer 31, the ratio of the depth of the vents to the diameter of the vents can be increased. Optimally, the ratio is equal to or larger than 6.

According to the above arrangement, in use of the air bearing structure 10, high-pressure gas is conducted into the porous main body 20 from outer side. The high-pressure gas then flows out from the throttling layer section 30. When the external high-pressure gas enters the air cavity 22 of the porous main body 20, due to the stop of the base section 21, the flow speed of the high-pressure gas is slowed down. Then, under the damping effect of the porous main body 20, the high-pressure gas is conducted by the matrix of vents 32 of the throttling layer section 30 to flow out. Accordingly, the vents 32 serve to regulate the outgoing gas to flow out in a unified direction. This ensures that the gas flows in a laminar flow state to achieve better air film stability.

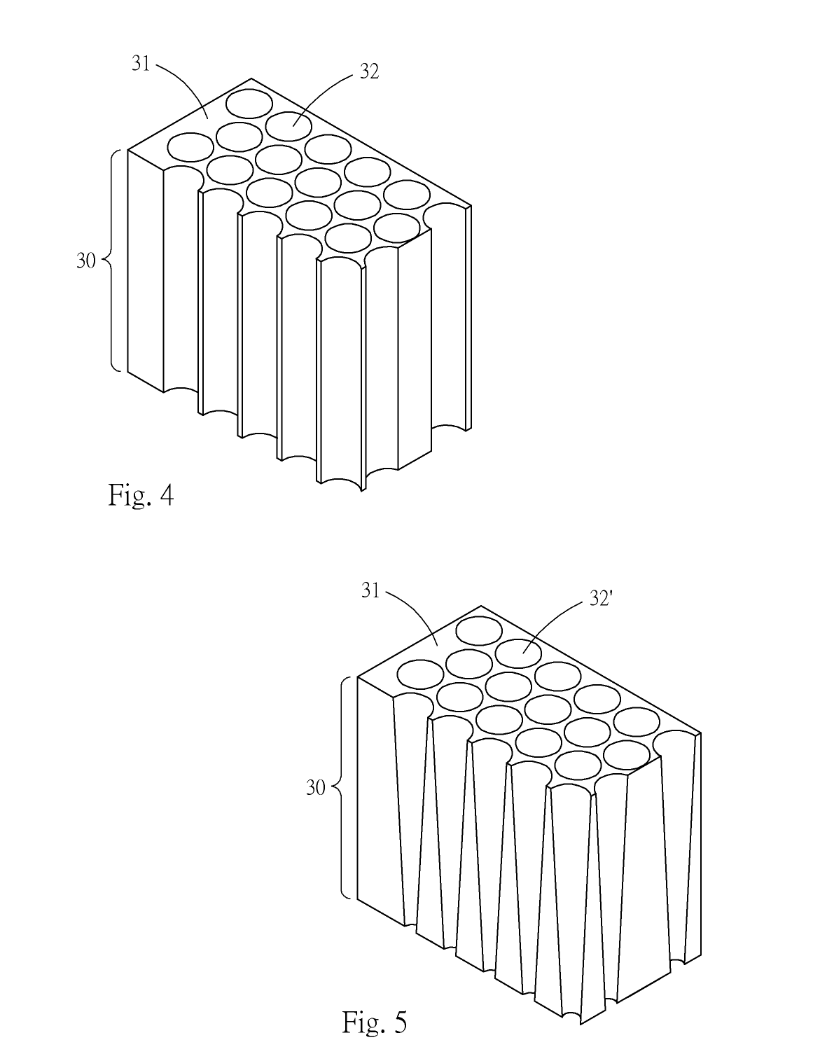

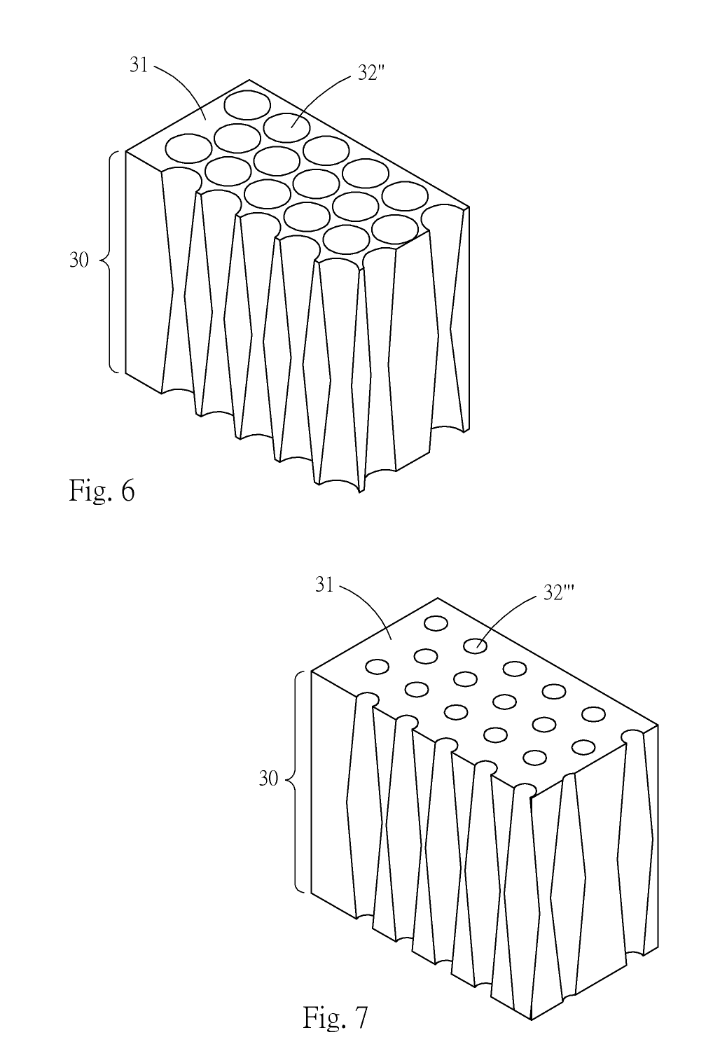

In addition, it should be further noted that in the first embodiment, the vents are formed by means of anodic oxidation process as an example. Practically, the vents formed by such process tend to have unified diameter. That is, the vents 32 of the first embodiment are within a certain tolerance range and can be referred to as straight vents with unified diameter. However, the protection range of the present invention is not limited to the first embodiment and many modifications of the first embodiment should be also included in the scope of the present invention. For example, as shown in FIGS. 5 to 7 of the second to fourth embodiments of the present invention, the vents can be conic vents 32′ two ends of which have different diameters, middle-narrowed vents 32″ the middle of which has a smaller diameter or middle-bulged vents 32′″ two ends of which have smaller diameter.

Furthermore, the vents 32 can be alternatively formed by other method other than anodic oxidation process. For example, the vents can be formed by means of ultrasonic machining (USM), electrochemical machining (ECM), electrical discharge machining (EDM), laser beam machining (LBM) or electronic beam machining (EBM) or the like conventional micro-hole machining technique.

The above embodiments are only used to illustrate the present invention, not intended to limit the scope thereof. Many modifications of the above embodiments can be made without departing from the spirit of the present invention.

What is claimed is:

1. An air bearing structure comprising:
a porous main body having a base section and an air cavity formed in the base section, the air cavity being composed of multiple voids formed in the base section in communication with each other; and
a throttling layer section disposed on one face of the porous main body, the throttling layer section being formed of an aluminum layer having multiple vents with predetermined length, the vents passing through the aluminum layer and being directed in the same direction in communication with the air cavity.

2. The air bearing structure as claimed in claim 1, wherein the aluminum layer is formed on the face of the porous main body by means of physical vapor deposition (PVD).

3. The air bearing structure as claimed in claim 1, wherein the vents are formed by a means selected from a group consisting of ultrasonic machining (USM), electrochemical machining (ECM), electrical discharge machining (EDM), laser beam machining (LBM) or electronic beam machining (EBM) and anodic oxidation process (AAO) or the like micro-hole machining method.

4. The air bearing structure as claimed in claim 1, wherein the aluminum layer has a thickness ranging from 3 to 5 micrometers (μm).

5. The air bearing structure as claimed in claim 1, wherein the vents are arranged in the aluminum layer at equal intervals with a size ranging 250 to 450 nanometers (nm).

6. The air bearing structure as claimed in claim 1, wherein a ratio of the depth of the vents to the diameter of the vents is equal to or larger than 6.

7. The air bearing structure as claimed in claim 1, wherein two ends of each vent have equal diameters.

8. The air bearing structure as claimed in claim 1, wherein two ends of each vent have different diameters.

9. The air bearing structure as claimed in claim 7, wherein a middle section of each vent has a diameter larger than the diameter of two ends of the vent.

10. The air bearing structure as claimed in claim 7, wherein a middle point of each vent has a diameter smaller than the diameter of two ends of the vent.
